(19) United States
(12) Patent Application Publication
(10) Pub. No.: US 2012/0040068 A1
(43) Pub. Date: Feb. 16, 2012

(54) Citrus product as replacement in food items

(76) Inventor: Winsor G. Eveland, Englewood, FL (US)

(21) Appl. No.: 12/806,287

(22) Filed: Aug. 10, 2010

(51) Int. Cl. A23L 1/2165; A21D 2/36; A23L 1/212

(52) U.S. Cl. 426/549; 426/665; 426/429

(57) ABSTRACT

The present invention is directed to certain food stuffs wherein certain ingredients in foods are substituted by a product made of citrus peel that has been ground to a powder to form a citrus product. The certain ingredients in the foodstuff are, for example, milk and eggs. The citrus product has oils contained therein that are reduced from 78% in some instances and to 1.8% in other instances. Depending on the use, the citrus product could be used to substitute certain meats in certain foods to render them meatless the result being the same in taste and the same in appearance. In other instances, the citrus product is used as a substitute in deep frying foods and as a replacement in the batter that makes breads, muffins or cornstarch. Again the result is the same as mentioned above.

### BACKGROUND OF THE INVENTION

The invention relates to foods and the process for replacing a citrus product in food items. More particularly, the invention is directed to a method of using processed citrus peel after it has been ground to a powder and the juice has been removed there from.

Nearly 50 billion pounds of citrus are processed each year, mainly to extract drinkable juices for the consumer market. There are several US patents that are directed to using the citrus peels and transform them into a pulp which is mostly used as an animal feed or a fertilizer.

U.S. Pat. No. 2,215,944 discloses foods that are obtained from citrus fruit waste such as the peels and the resulting product is suitable as a foodstuff for humans and as a cattle feed.
U.S. Pat. No. 4,547,226 describes a process for enhancing the sugar content of citrus press liquor by separating citrus solids, extracting fructose, glucose and sucrose from the solids, and recombining the aqueous extract to increase the sugar content thereof. This is a far removed process of the disclosed inventive concept.
U.S. Pat. No. 6,151,799 discloses a process for processing waste citrus peel to remove oil from the peel for subsequent processing. The process is directed to a system for treatment of large volumes of citrus peel to be converted into useful products. The resulting peel particles can be rendered food grade quality for human consumption. Again, it is reiterated that the product can be used for animal feed.
U.S. Pat. No. 7,060,313 describes a process for processing citrus peel to produce food grade products by pressing and drying the citrus peel.
All of the patents, cited above, do not disclose any of the inventive contemplated objects of the substitution of components or ingredients in food stuff by processed citrus peel.

### BRIEF DESCRIPTION OF THE INVENTION

The inventive process uses the peel of the citrus fruit which has been processed into a powder to replace the milk and the eggs in a chicken frying process, for example. The resulting taste cannot be discerned as being different from the batter that was used including milk and eggs. Even the appearance of the resulting food product is not nay different from the former.

### DETAILED DESCRIPTION OF THE INVENTION

There are two different citrus products that can be obtained by the processes disclosed in the cited patents above:

1) A CITRA BLEND it contains 78% of the oil inherently present in the citrus peel.

This citrus product is used as a replacement in the batter containing eggs and milk as a substitute.
It is useful in the production of breads, muffins, corn bread, partial gum replacement, dough conditioned replacement, as a clouding agent in drinks and many others. Many European breads are known to have a hard crust. This can be changed by substituting the eggs and milk for the above mentioned CITRA BLEND in the batter. It is most useful when deep frying chicken and other product. However the taste and the appearance remains the same. The question is raised why use it as a substitute as suggested above? The answer is: because it is much cheaper than using eggs and milk. Millions of deep fryers are used during a year and the cheaper version will greatly impact on the cost of operation.

2) A CITRA FIBER it contains 1.8% of oil Inherently present in the citrus peel. It is most useful for preparing food stuff for diabetic persons because the sugar and the pectins in the processed citrus peel is mostly removed. Pectin is the white part under the skin of the peel in an orange.

Another use of the CITRA FIBERS is a replacement of the meats in hot dogs, hamburgers by replacing the gums. The substitution of the citrus product in the above named meats renders the products so called “meatless”. This substitution behaves and tastes like the former meat products.
Another example is found in the treatment of hams. Picnic hams, for example are treated or soaked in a brine. By soaking the ham in a solution of the citrus product, the artificial cure is removed including the nitrates and replaces the gums in meat.
Many of the Value Added products which incorporate Citra Fiber™ and existing “off shelf” ingredients. The list of the various processes appears below:

| Advanced Projects | In Process |
|---|---|
| Breads | Cures (brine agents) |
| Muffins | Cheese Replacements |
| Nutrition | (analogs) |
| Egg Replacement | Cream Cheese Replace |
| Milk Replacement | Gluten Replacement |
| Batter Replacement | Antioxidant Value Booster |
| Partial Gum Replacement | Nutraceutical Ingredient |
| Dough Conditioner | Flavor Enhancer |
| Replacement | (gravy/sauce) |
| Clouding Agent | Fat Replacement |
| Vegetarian Line/Meat | Salad Dressing Ingredient |
| Analogs | Mayonnaise Ingredient |
| Fiber Booster | Topical Ointments (sun) |
| Power/Energy bars | Chelation (heavy metal |
| Tortilla (lard replacement) | removal) |
| Candy Ingredient | Fruit Shelf Life Extender |
| Syneresis Control (water | Dietary Ingredient |
| Binding) | |
| Broth Extension | |

What I claim is:

1. A process for treating food stuff having predetermined components therein, the steps of preparing a citrus peel powder and substituting said powder for said predetermined components.

2. The process of claim 1, wherein said predetermined components are eggs and milk.

3. The process of claim 1, wherein said foodstuff is selected from the group of foods consisting of breads, muffing or cornstarch.

4. The process of claim 1, wherein said citrus peel powder has an oil content of 78%.

5. The process of claim 1, wherein said citrus peel powder has an oil content of 1.8%.

6. The process of claim 5, wherein citrus peel powder is used to soak a ham in a watery solution of said powder to thereby remove the initial cure elements and the nitrates contained in said ham.

7. The process of claim 1, wherein said citrus peel powders are used as a substitute for meats in so-called hot dogs and hamburgers to create a meatless product.
